(19) United States
(12) Patent Application Publication
(10) Pub. No.: US 2010/0073641 A1
(43) Pub. Date: Mar. 25, 2010

(54) DISPLAY DEVICE

(75) Inventors: Jung-Suk Han, Hwasung-si (KR); Jong-Seo Lee, Hwasung-si (KR); Tae-Jong Jun, Suwon-si (KR); Joo-Young Lee, Yongin-si (KR); Soo-Lin Kim, Seoul (KR)

Correspondence Address: Innovation Counsel LLP, 21771 Stevens Creek Blvd, Ste. 200A, Cupertino, CA, 95014, US

(73) Assignee: Samsung Electronics Co., Ltd.

(21) Appl. No.: 12/563,020

(22) Filed: Sep. 18, 2009

(30) Foreign Application Priority Data
Sep. 19, 2008 (KR) 10-2008-0092252

(51) Int. Cl. G03B 3/10; G03B 21/14

(52) U.S. Cl. 353/38

(57) ABSTRACT

A liquid crystal display is provided having improved image quality and visibility. The display device includes: a plurality of display panels which display multiple images from multiple display panels; a projection film which overlaps the display panels; and a lens panel including a first lens unit and a second lens unit is interposed between the display panel and the projection film. The first lens unit refracts images and the second lens unit improves image brightness. Therefore the resultant projection is a seamlessly connected image from the multiple display panels.

### REFERENCE TO RELATED APPLICATIONS

This application claims priority from Korean Patent Application No. 10-2008-0092252 filed on Sep. 19, 2008 in the Korean Intellectual Property Office, the disclosure of which is incorporated herein by reference in its entirety.

### BACKGROUND OF THE INVENTION

1. Field of the Invention

The present invention relates to a display device, and more particularly, to a display device including a plurality of display panels which form a large display surface with superior display quality.

2. Description of the Related Art

As modern society becomes more dependent on sophisticated information and communication technology, market needs for larger and thinner displays are growing. In particular, since conventional cathode ray tubes (CRTs) have failed to fully satisfy these market needs, the demand for flat panel displays (FPDs), such as plasma display panels (PDPs), plasma address liquid crystal display panels (PALCs), liquid crystal displays (LCDs), and organic light emitting diodes (OLEDs), is exploding. Since display devices have clear image quality and can be made lighter and thinner, they are widely used in various electronic devices.

LCDs are one of the most widely used FPDs. An LCD includes two display panels, on which electrodes are formed, and a liquid crystal layer which is interposed between the two display panels. The electric field formed by applying voltages to the electrodes rearranges the liquid crystal molecules and thus controls the amount of light passing through the liquid crystal layer. In this way, the LCD displays a desired image.

With the soaring demand for a large display surface, large display panels are being actively developed. However, the cost of developing large display panels is high; there is growing interest in technology for forming a large display surface by using a plurality of smaller display panels.

A conventional display panel has a display region where images are displayed and a non-display peripheral region where no images are displayed. Therefore, when a plurality of conventional display panels are arranged adjacent to each other to form a large display screen, their non-display regions are displayed as visible grids on the display screen. The screens of the display devices cannot be seamlessly merged for the viewer.

### SUMMARY OF THE INVENTION

Aspects of the present invention provide a large display device formed from a plurality of smaller display panels, which demonstrate superior display quality.

However, aspects of the present invention are not restricted to the one set forth herein. The above and other aspects of the present invention will become more apparent to one of ordinary skill in the art to which the present invention pertains by referencing the detailed description of the present invention given below.

According to one aspect of the present invention, a display device is provided including: a display panel which displays an image; a projection film which overlaps the display panel; and a lens panel which includes a first lens unit and is interposed between the display panel and the projection film, wherein the first lens unit receives and refracts the image from the display panel and projects the image onto the projection film.

adjusts an output direction of the image by refracting the image input thereto and projects the image onto the projection film.

According to another aspect of the present invention, a display device is provided including: a plurality of display panels which are arranged adjacent to each other, and each panel includes a display region where an image is displayed and a non-display region where the image is not displayed; a projection film which overlaps the display panels; and a lens panel, interposed between the display panels and the projection film, includes a first lens unit and a second lens unit. The first lens unit adjusts an image output direction images seamlessly on the projection film wherein the display panels have a portion formed by the non-display regions which are disposed adjacent to each other, and the first lens unit projects the image onto a region of the projection film which overlaps the non-display regions.

### BRIEF DESCRIPTION OF THE DRAWINGS

The above and other aspects and features of the present invention will become more apparent by describing in detail the exemplary embodiments thereof with reference to the attached drawings, in which:

FIG. 1 is an exploded perspective view of a display device according to a first exemplary embodiment of the present invention;

FIG. 2 is a schematic cross-sectional view of the display device shown in FIG. 1;

FIG. 3 is an enlarged cross-sectional view of a region A shown in FIG. 2;

FIG. 4 is a perspective view of a first lens unit included in the display device of FIG. 1;

FIG. 5A is a perspective view of the first lens unit included in the display device of FIG. 1 after a voltage is applied to the first lens unit;

FIG. 5B is a cross-sectional view of the first lens unit shown in FIG. 5A;

FIG. 6 is a perspective view of a second lens unit included in the display device of FIG. 1;

FIG. 7A is a perspective view of the second lens unit included in the display device of FIG. 1 after a voltage is applied to the second lens unit;

FIG. 7B is a cross-sectional view of the second lens unit shown in FIG. 7A;

FIG. 8A is a cross-sectional view of a first lens unit included in a display device according to a second exemplary embodiment of the present invention;

FIG. 8B is a cross-sectional view of the first lens unit of FIG. 8A after an electric field is applied thereto;

FIG. 9 is a perspective view of lens panels and display panels included in a display device according to a third exemplary embodiment of the present invention;

FIG. 10 is a perspective view of a first lens unit included in the display device of FIG. 9;

FIG. 11 is a perspective view of a second lens unit included in the display device of FIG. 9;

FIG. 12 is a perspective view of display panels and lens panels included in a display device according to a fourth exemplary embodiment of the present invention;

FIG. 13 is a schematic cross-sectional view of the display device shown in FIG. 12;

FIG. 14 is a perspective view of a multi-display apparatus having a plurality of display devices arranged adjacent to each other according to an exemplary embodiment of the present invention; and

FIG. 15 is a schematic cross-sectional view of the multi-display apparatus shown in FIG. 14.

### DETAILED DESCRIPTION OF THE INVENTION

Advantages and features of the present invention and methods of accomplishing the same may be understood more readily by reference to the following detailed description of exemplary embodiments and the accompanying drawings. The present invention may, however, be embodied in many different forms and should not be construed as being limited to the embodiments set forth herein. Rather, these embodiments are provided so that this disclosure will be thorough and complete and will fully convey the concepts of the invention to those skilled in the art, and the present invention will only be defined by the appended claims. Like reference numerals refer to like elements throughout the specification.

Spatially relative terms, such as “below”, “beneath”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures.

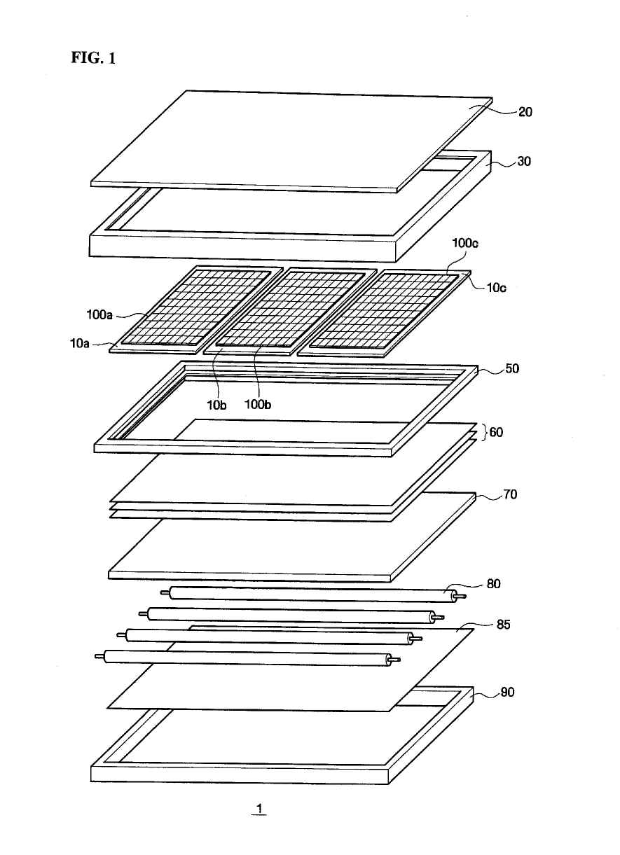

Hereinafter, a display device 1 according to a first exemplary embodiment of the present invention will be described in detail with reference to FIG. 1. FIG. 1 is an exploded perspective view of the display device 1 according to the first exemplary embodiment of the present invention.

Referring to FIG. 1, the display device 1 according to the first exemplary embodiment includes first through third display panels 10a to 10c, first through third lens panels 100a to 100c, a projection film 20, an upper housing 30, an intermediate frame 50, optical sheets 60, a diffusion plate 70, lamps 80, a reflective sheet 85, and a lower housing 90.

Each of the first through third display panels 10a to 10c includes a lower display panel and an upper display panel which faces the lower display panel. The lower display panel includes gate lines, data lines, a thin-film transistor (TFT) array, pixel electrodes, and the like. The upper display panel includes a black matrix, a common electrode, and the like. Each of the first through third display panels 10a to 10c displays image information.

Each of the first through third display panels 10a to 10c may be connected to a printed circuit board (PCB) (not shown) which provides gate driving signals and data driving signals.

Each of the first through third display panels 10a to 10c is a unit panel that displays an image. The first through third display panels 10a to 10c are disposed adjacent to each other to form a large screen. The first through third display panels 10a to 10c may be arranged in various ways. In addition, the display device 1 according to the first exemplary embodiment may include various numbers of display panels. That is, the first through third display panels 10a to 10c may be arranged in a horizontal direction to form a horizontally long screen. Alternatively, the first through third display panels 10a to 10c may be arranged in a vertical direction to form a vertically long screen. Since each of the first through third display panels 10a to 10c is a unit panel that displays an image, it may be considered as a single unit block.

The projection film 20 is disposed above the first through third display panels 10a to 10c. The projection film 20 overlaps each of the display panels 10a to 10c and provides a screen that a user actually sees. That is, an image provided by each of the first through third display panels 10a to 10c is projected onto the projection film 20 seen by an user.

The projection film 20 is made of an opaque material to prevent the first through third display panels 10a to 10c from being seen. Thus, nothing other than an image is visible on the projection film 20. An opaque material, such as a diffusion sheet or a diffusion plate, may be used as the projection film 20.

The first through third lens panels 100a to 100c are attached between the display panels 10a to 10c and the projection film 20, respectively. The lens panels 100a to 100c enable images from the display panels 10a to 10c to project onto the projection film 20. Specifically, the first through third lens panels 100a to 100c control the directions in which the images on the display panels 10a to 10c will show on the projection film 20, respectively, as seamless images on the entire surface of the projection film 20. Thus, the first through third lens panels 100a to 100c refract images output from surfaces of the first through third display panels 10a to 10c, respectively, so that the resultant images can be seamlessly displayed on the entire surface of the projection film 20.

The first through third lens panels 100a to 100c may magnify image output from the first through third display panels 10a to 10c, respectively, and project the magnified images onto the projection film 20. In addition, the first through third lens panels 100a to 100c may magnify or refract at least part of images from edge portions of a combined surface of the first through third display panels 10a to 10c and project the edge images to the edge portions of the projection film 20.

The first through third display panels 10a to 10c, the first through third lens panels 100a to 100c, and the projection film 20 will be described in more detail later.

The upper housing 30 forms the exterior of the display device 1 and has space to accommodate the first through third display panels 10a to 10c. In addition, an open window is formed in the center of the upper housing 30 to expose the first through third display panels 10a to 10c.

The projection film 20 is disposed above the first through third display panels 10a to 10c. The projection film 20 may be housed in the upper housing 30, together with the first through third display panels 10a to 10c. Alternatively, the projection film 20 may be disposed on the upper housing 30 as shown in FIG. 1.

The upper housing 30 is coupled to the lower housing 90 with the intermediate frame 50 interposed therebetween.

The intermediate frame 50 accommodates the optical sheets 50, the diffusion plate 70, and the lamps 80 therein. In addition, the intermediate frame 50 is firmly fixed to the lower housing 90. The intermediate frame 50 includes sidewalls which are formed along rectangular edges thereof. An open window is formed in the center of the intermediate frame 50 to pass light that comes from the diffusion plate 70 and the optical sheets 60.

The optical sheets 60 diffuse and concentrate light received from the diffusion plate 70. The optical sheets 60 are disposed on the diffusion plate 70 and housed in the intermediate frame 50. The optical sheets 60 include a first prism sheet, a second prism sheet, and a protective sheet.

The first and second prism sheets refract light after the diffusion plate 70 and concentrate the light to the front of the display device 1 at a low incidence angle, thereby enhancing the brightness of the display device 1 within an effective viewing angle range.

The protective sheet is formed on the first and second prism sheets. The protective sheet not only protects surfaces of the first and second prism sheets but also diffuses light more uniformly. The configuration of the optical sheets 60 is not limited to the above example and may vary according to specifications of the display device 1.

The diffusion plate 70 diffuses light emitted from the lamps 80 in all directions. The diffusion plate 70 prevents bright spots of the lamps 80 from being seen at the front of the display device 1.

The optical sheets 60 may be separated from the diffusion plate 70. Alternatively, the optical sheets 60 and the diffusion plate 70 may be integrated into a single optical member.

The lamps 80 may be line lamps such as cold cathode fluorescent lamps (CCFLs) and hot cathode fluorescent lamps (HCFLs). When the lamps 70 are HCFLs, each of the HCFLs includes two terminals at each end.

The reflective sheet 85 is disposed under the lamps 80 and reflects light, which is emitted downward from the lamps 80, back upward, thereby enhancing light efficiency.

The display device 1 according to the first exemplary embodiment uses a direct-type backlight assembly in which the lamps 80 are arranged directly under the display panels 10a to 10c. However, the present invention is not limited thereto. That is, the display device 1 may also use an edge-type backlight assembly in which lamps are disposed under one or more sidewalls of a display panel and in which light emitted from the lamps is delivered to the display panel via a light guide plate.

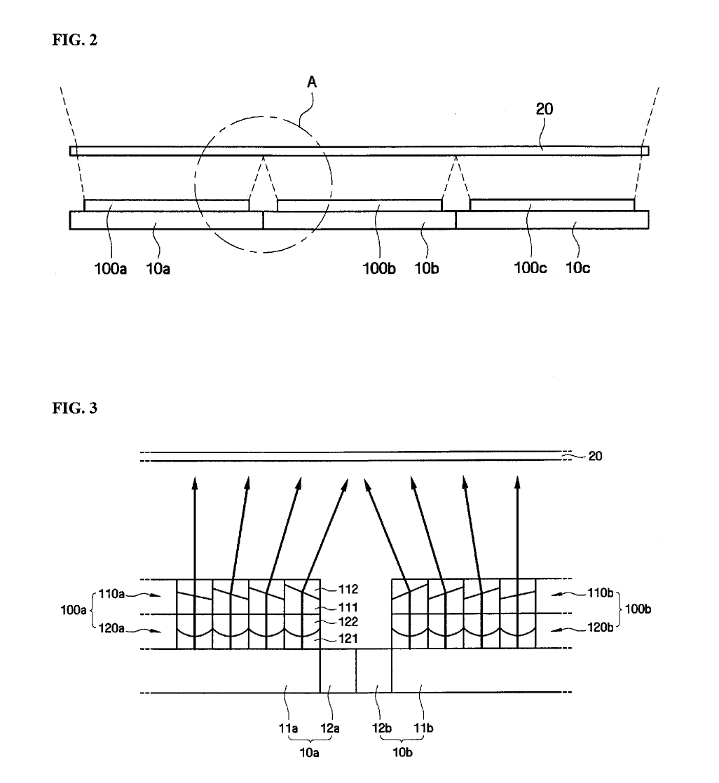

Hereinafter, an image projection process of the display device 1 according to the first exemplary embodiment will be described in detail with reference to FIGS. 2 and 3. FIG. 2 is a schematic cross-sectional view of the display device 1 shown in FIG. 1. FIG. 3 is an enlarged cross-sectional view of a region A shown in FIG. 2.

The first through third display panels 10a to 10c are disposed under the projection film 20. The projection film 20 may have a large area overlapping all the display panels 10a to 10c. In this specification, a case where three display panels, i.e., 10a to 10c, are arranged in a straight line will be described as an example. However, the present invention is not limited to the example. That is, a plurality of display panels may be arranged in various forms, and the same principle may apply irrespective of the arrangement of the display panels.

The first through third display panels 10a to 10c are disposed under the projection film 20. In addition, the first through third lens panels 100a to 100c are disposed on the first through third display panels 10a to 10c, respectively.

The first through third display panels 10a to 10c may be identical or may be different from each other in size, shape, or the like. The display device 1 according to the first exemplary embodiment uses identical display panels 10a to 10c. Therefore, a description of the first display panel 10a may also apply to the second and third display panels 10b and 10c.

The first display panel 10a includes a display region 11a where images are displayed and a non-display region 12a where no images are displayed. Since the display region 11a includes a plurality of pixels arranged in a matrix, it can display images. The non-display region 12a surrounds the display region 11a.

When the first through third display panels 10a through 10c are successively arranged adjacent to each other, the display region 11a and the non-display region 12a of the first display panel 10a, a display region 11b and a non-display region 12b of the second display panel 10b, and a display region (not shown) and a non-display region (not shown) of the third display panel 10c overlap the projection film 20. That is, the non-display regions 12a and 12b of the first and second display panels 10a and 10b and the non-display region (not shown) of the third display panel 10c may exist in the form of lines in a large screen formed by the first through third display panels 10a to 10c which are connected to each other.

In order to prevent the non-display regions 12a and 12b of the first and second display panels 10a and 10b and the non-display region (not shown) of the third display panel 10c from being seen, the first through third lens panels 100a to 100c are formed on the display regions 11a and 11b of the first and second display panels 10a and 10b and the display region (not shown) of the third display panel 10c, respectively. The first through third lens panels 100a to 100c refract images away from the display regions 11a and 11b of the first and second display panel 10a and 10b and the display region of the third display panel 10c to areas of the projection film 20 which overlap the non-display regions 12a and 12b of the first and second display panels 10a and 10b and the display region of the third display panel 10c, respectively. Since the images are projected onto the areas of the projection film 20 which overlap the non-display regions 12a and 12b of the first and second display panels 10a and 10b and the non-display region of the third display panel 10c as described above, the non-display regions 12a and 12b of the first and second display panels 10a and 10b and the non-display region of the third display panel 10c are not shown on the projection film 20.

The first lens panel 100a includes a first lens unit 110a which adjusts an output direction of an image by refracting the image input thereto and a second lens unit 120a which focuses the image. The first lens unit 110a contains two materials having different refractive indices, and an interface is formed between the two materials. Light changes its path as it passes through the interface between the two materials. That is, the first lens unit 110a refracts an image away from the display region 11a so that the image can be displayed on a region of the projection film 20 overlapping the non-display region 12a.

The first lens unit 110a may be formed along the non-display region 12a and divided into a plurality of sections. Therefore, the first lens unit 110a which is divided into a plurality of sections may be formed on pixels of the display region 11a which is adjacent to the non-display region 12a. Here, each section of the first lens unit 110a may correspond to a pixel or a plurality of pixels. A tilt angle of a refracting interface of the two materials of the first lens unit 110a may be gradually reduced as the lens' distance from the non-display region 12a increases.

The second lens unit 120a is formed between the first display panel 10a and the first lens unit 110a and focuses an image that is received from the first display panel 10a. That is, an image output from the first display panel 10a spreads as the distance from the first display panel 10a increases, thereby overlapping images of adjacent pixels. To prevent this problem, the second lens unit 120a focuses the image and provides the focuses image to the first lens unit 110a.

For a light focus function, the second lens unit 120a may use a convex lens having a concave refracting surface. A focal distance of the convex lens may be gradually reduced as the distance from the non-display region 12a increases.

Each of the first lens unit 110a and the second lens unit 120a may be made of a solid or a liquid material having a refracting interface that varies with a voltage applied thereto. The liquid material may be contained in transparent container which has the same refractive index as the liquid.

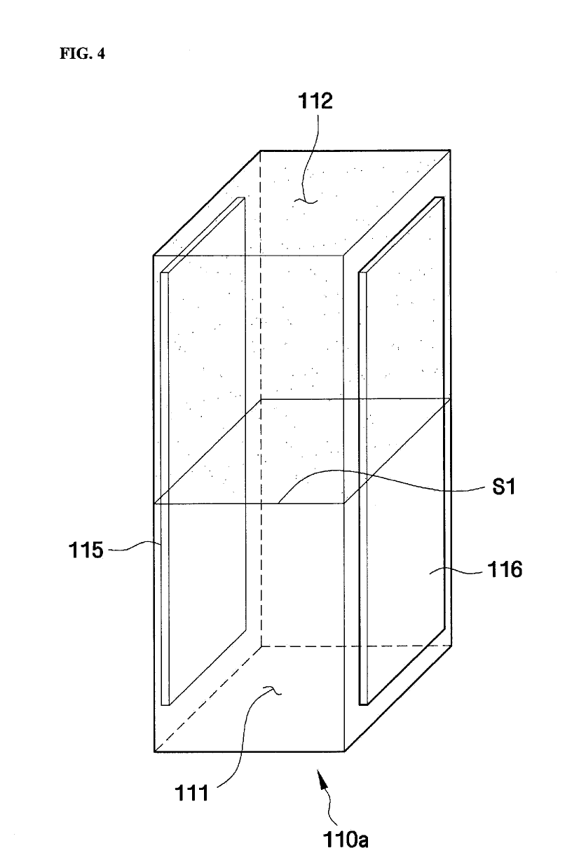

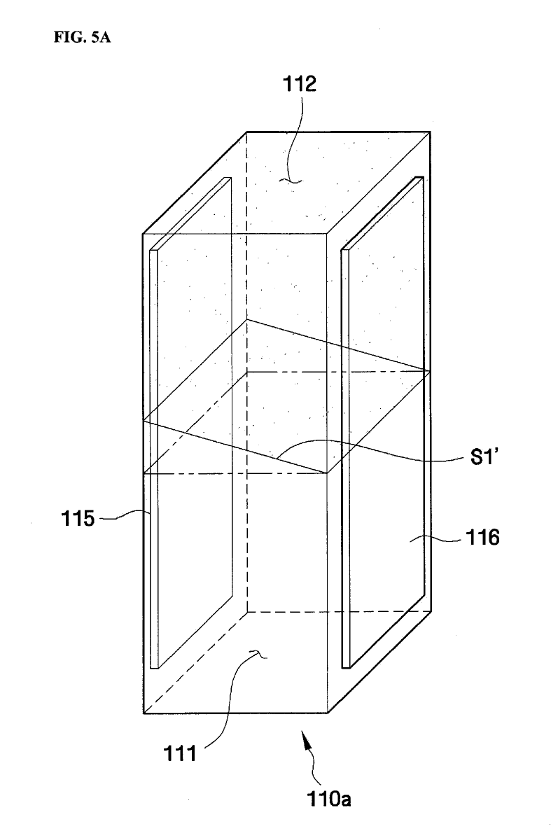

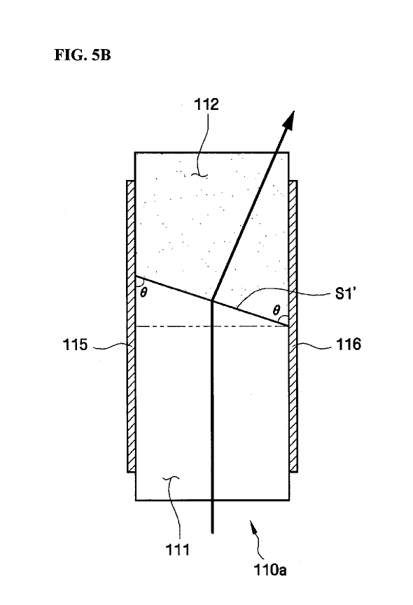

The first lens unit 110a will now be described in more detail with reference to FIGS. 4 through 5B. FIG. 4 is a perspective view of the first lens unit 110a included in the display device 1 of FIG. 1. FIG. 5A is a perspective view of the first lens unit 110a included in the display device 1 of FIG. 1 after a voltage is applied to the first lens unit 110a. FIG. 5B is a cross-sectional view of the first lens unit 110a shown in FIG. 5A.

The first lens unit 110a includes a liquid lens having a first liquid 111 and a second liquid 112. The angle of a refracting surface of the first lens unit 110a varies with a voltage applied to the first lens unit 110a.

The first liquid 111 and the second liquid 112 may have different refractive indices so that the interface can function as a lens. One of the liquids may be hydrophilic, and the other one may be hydrophobic, so they will not mix with each other. For example, the first liquid 111 may be water with a refractive index of 1.33, and the second liquid 112 may be oil with a refractive index of 1.6.

In addition, one of the liquids may be conductive. When a voltage is applied to the conductive liquid, the interface S1 may change due to the effect of an electric field. However, the present invention is not limited thereto, and other materials that satisfy the above conditions may also be used.

First and second electrodes 115 and 116 are respectively located on opposite sides of the first liquid 111 and the second liquid 112 facing each other. Each of the first and second electrodes 115 and 116 is at least partially overlaps the first liquid 111 and the second liquid 112.

Referring to FIG. 4, when no voltage is applied to the first and second electrodes 115 and 116, the first liquid 111 and the second liquid 112 are separated from each other as a lower layer and an upper layer, respectively. Thus, the interface S1 is flat between the first liquid 111 and the second liquid 112. In this case, light travels straight through the first liquid 111 and the second liquid 112 without changing its direction.

Referring to FIG. 5A, when voltages are applied to the first and second electrodes 115 and 116, the interface S1′ (S1′ indicating S1 is under voltage in FIGS. 5A and 5B) tilts to a side. That is, when different voltages are applied to the first and second electrodes 115 and 116, there occurs a potential difference between the first and second electrodes 115 and 116. Then, electric fields are generated within the first liquid 111 and the second liquid 112. In this case, the boundary surface S1′ between the first liquid 111 and the second liquid 112 may tilt such that an end of the boundary surface S1′ adjacent to one of the first and second electrodes 115 and 116, to which a higher voltage has been applied, is placed higher than the other end of the boundary surface S1′ adjacent to the other one of the first and second electrodes 115 and 116 to which a lower voltage has been applied. That is, an end of the boundary surface S1′ adjacent to one of the first and second electrodes 115 and 116, to which a higher voltage has been applied, is raised while the other end of the boundary surface S1′ adjacent to the other one of the first and second electrodes 115 and 116, to which a lower voltage has been applied, is lowered. However, since the entire boundary surface S1′ remains flat, it becomes a flat surface that tilts at an angle to a side. In summary, when a voltage is applied to the electrodes 115 and 116, different electric fields exist in the two liquids of different refractive indices, applying different forces on the two electrodes at the top portion which overlapping the first liquid and the bottom portion overlapping the second liquid. This induces the first liquid rising at the higher voltage electrode side which then results in the tilting of the liquid interface. When the voltage varies, the interface tilt angle also varies.

Referring to FIG. 5B, a higher voltage may be applied to the first electrode 115 than to the second electrode 116. Then, the boundary surface S1′ between the first liquid 111 and the second liquid 112 tilts such that an end of the boundary surface S1′ adjacent to the first electrode 115 is placed higher than the other one of the boundary surface S1′ adjacent to the second electrode 116. In this case, light incident on the bottom of the first liquid 111 is refracted by the boundary surface S1′ between the first liquid 111 and the second liquid 112. When the boundary surface S1′ between the first liquid 111 and the second liquid 112 tilts at an angle of θ to the second electrode 116, the light incident on the bottom of the first liquid 111 is refracted toward the second electrode 116 and output accordingly. Therefore, light travel angle from the first lens unit 110a can be controlled by adjusting the voltages applied to the first and second electrodes 115 and 116.

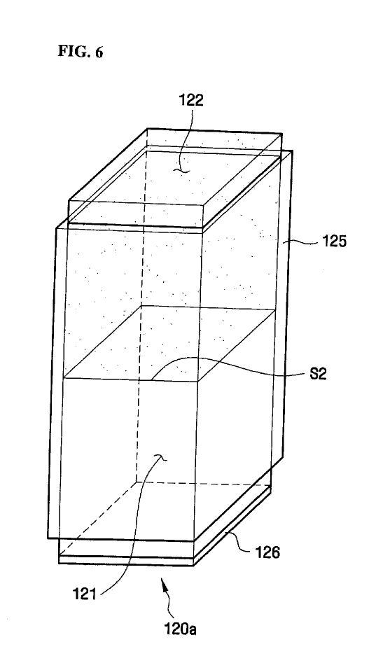

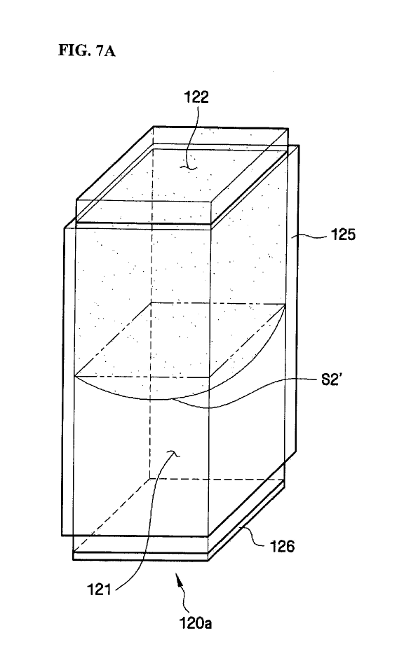

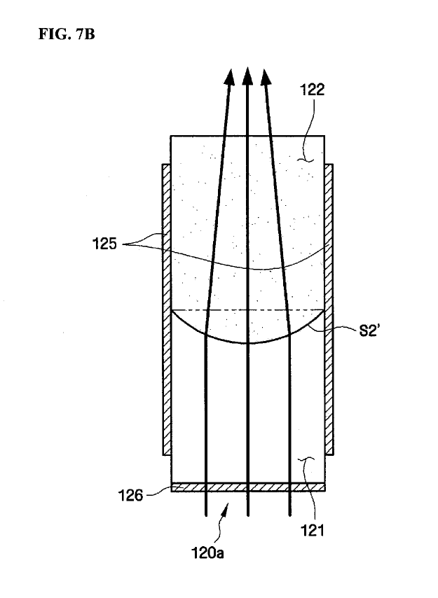

The second lens unit 120a will now be described in more detail with reference to FIGS. 6 through 7B. FIG. 6 is a perspective view of the second lens unit 120a included in the display device 1 of FIG. 1. FIG. 7A is a perspective view of the second lens unit 120a included in the display device 1 of FIG. 1 after a voltage is applied to the second lens unit 120a. FIG. 7B is a cross-sectional view of the second lens unit 120a shown in FIG. 7A.

The second lens unit 120a includes a liquid lens having a first liquid 121 and a second liquid 122. A refracting surface of the second lens unit 120a becomes concave or convex according to a voltage applied to the second lens unit 120a.

The first liquid 121 and the second liquid 122 may have different refractive indices so that the first liquid 111 and the second liquid 112 can function as a lens. One of the first liquid 121 and the second liquid 122 may be hydrophilic, and the second liquid 122 may be hydrophobic they do not mix with each other. For example, the first liquid 121 may be water with a refractive index of 1.33, and the second liquid 122 may be oil with a refractive index of 1.6.

In addition, one of the first liquid 121 and the second liquid 122 may be conductive. When a voltage is applied to the conductive liquid, the interface may change due to the effect of an electric field. However, the present invention is not limited thereto, and other materials that satisfy the above conditions may also be used. That is, the first liquid 121 and the second liquid 122 may use materials identical to those of the first liquid 111 (see FIG. 4) and the second liquid 112 (see FIG. 4) included in the first lens unit 110a (see FIG. 4) described above.

The first liquid 121 and the second liquid 122 are separated from each other as a lower layer and an upper layer, respectively. Thus, an interface is formed between the first liquid 121 and the second liquid 122 on top of the first liquid 121.

A first electrode 125 is disposed on four sidewalls of the first liquid 121 and the second liquid 122. The first electrode 125 may surround both liquids 121 and 122. That is, the first electrode 125 may surround the interface S2 between the liquids 121 and 122.

In addition, a second electrode 126 is disposed under the first liquid 121 and/or on the second liquid 122. That is, the second electrode 126 may be disposed in contact with at least one of the first liquid 121 and the second liquid 122.

Referring to FIG. 6, when no voltage is applied to the first and second electrodes 125 and 126, the first liquid 121 and the second liquid 122 are separated from each other as a lower layer and an upper layer, respectively. Thus, a flat interface is formed between the first liquid 121 and the second liquid 122. In this case, light incident on the bottom of the first liquid 121 travels straight through the top of the second liquid 122 without refracting at the interface S2.

Referring to FIG. 7A, when voltages are applied to the first and second electrodes 125 and 126, the interface S2′ (“′” indicating that voltage is applied in FIGS. 7A and 7B) between the first liquid 121 and the second liquid 122 may be curved downward or upward. The electric field is not uniform within the first liquid 121 and the second liquid 122. In this case, interface S2′ between the liquids 121 and 122 is curved and thus functions as a concave lens or a convex lens. Here, since the second liquid 122 has a higher refractive index than the first liquid 121, if the interface S2′ is curved downward, it may function as a convex lens.

Referring to FIG. 7B, the interface S2′ between the first liquid 121 and the second liquid 122 of the second lens unit 120 is curved downward to function as a convex lens. In this case, light incident on the bottom of the first liquid 121 is refracted at the interface S2′ between the first liquid 121 and the second liquid 122, and is curved to form a convex lens, light incident on the bottom of the first liquid 121 converges at a focal point of the convex lens and is output accordingly. A focal distance of the convex lens can be controlled by adjusting voltages applied to the first and second electrodes 125 and 126.

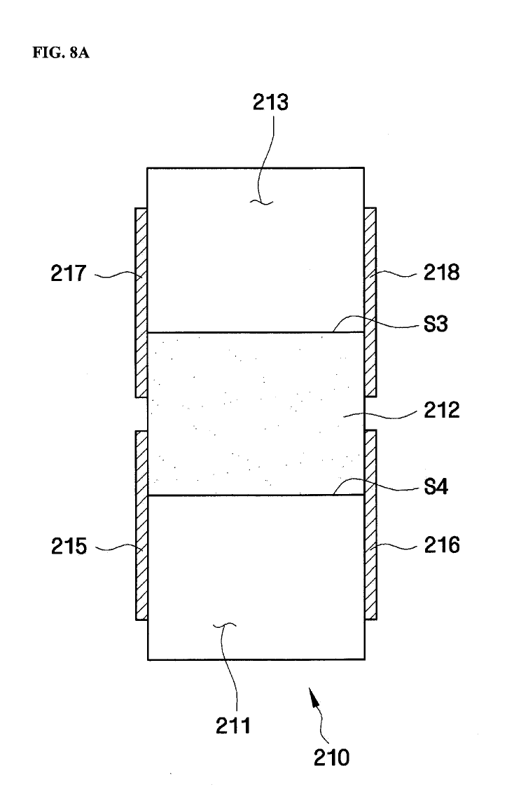

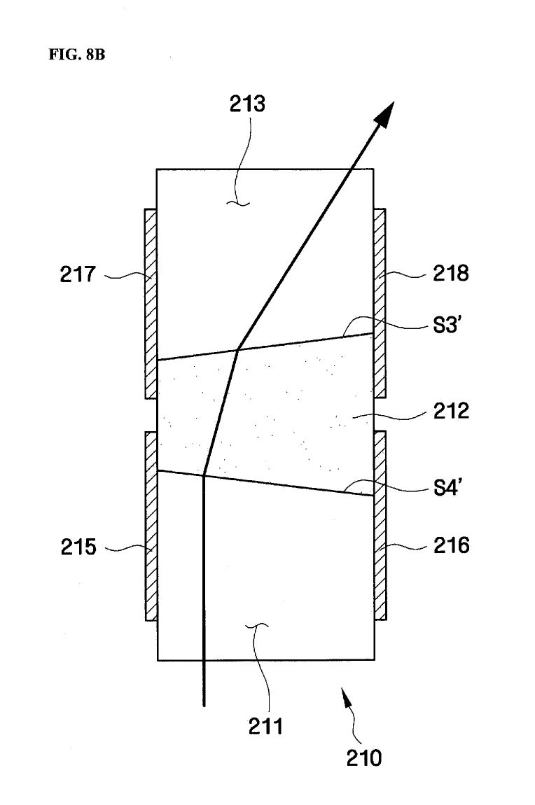

Hereinafter, a display device according to a second exemplary embodiment of the present invention will be described in detail with reference to FIGS. 8A and 8B. FIG. 8A is a cross-sectional view of a first lens unit 210 included in the display device according to the second exemplary embodiment of the present invention. FIG. 8B is a cross-sectional view of the first lens unit 210 of FIG. 8A after an electric field is applied thereto. Elements having the same functions as those shown in the drawings for the first exemplary embodiment are indicated by like reference numerals, and thus their description will be omitted.

The first lens unit 210 included in the display device according to the second exemplary embodiment includes a first layer 211, a second layer 212, and a third layer 213. The first through third layers 211 to 213 are sequentially stacked from bottom to top in this order. The first and third layers 211 and 213 may be made of the same liquid, and the second layer 212 may be made of a liquid having a different refractive index from that of the liquid of the first and third layers 211 and 213. That is, the first and third layers 211 and 213 may be made of, for example, the first liquid 111 (see FIG. 4) described above in the first exemplary embodiment, and the second layer 212 may be made of the second liquid 112 (see FIG. 4) of the first exemplary embodiment.

First and second electrodes 215 and 216 are respectively disposed on both sides of the first and second layers 211 and 212 to face each other. In addition, third and fourth electrodes 217 and 218 are respectively disposed on both sides of the second and third layers 212 and 213 to face each other.

The first and second electrodes 215 and 216 are separated from the third electrode 217 and the fourth electrode 218, respectively. The first and second electrodes 215 and 216 control a first interface S4′ between the first layer 211 and the second layer 212, and the third and fourth electrodes 217 and 218 control a second interface S3′ between the second and third layers 212 and 213. As described above, when different voltages are applied to the first and second electrodes 215 and 216, the first interface S4′ tilts at an angle. In addition, when different voltages are applied to the third and fourth electrodes 217 and 218, the second interface S3′ tilts at an angle. That is, angles at which the first interface S4′ and the second interface S3′ tilt can be controlled independently by adjusting voltages applied to the first and second electrodes 215 and 216 and to the third and fourth electrodes 217 and 218.

Referring to FIG. 8A, when no voltage is applied to any electrodes, the first and second interfaces S4 and S3 do not tilt but remain horizontal. Referring to FIG. 8B, when voltages are applied to the first and second electrodes 216 and to the third and fourth electrodes 217 and 218, the first and second boundary surfaces S4 and S3 tilt at predetermined angles with respect to a horizontal surface, respectively. Angles at which the first and second boundary surfaces S4 and S3 tilt with respect to the horizontal surface can be controlled independently by adjusting voltages applied to the first and second electrodes 215 and 216 independently of adjusting voltages applied to the third and fourth electrodes 217 and 218. By adjusting voltages applied to the first and second electrodes 215 and 216 independently of adjusting voltages applied to the third and fourth electrodes 217 and 218, the path of light incident on the bottom of the first layer 211 can be controlled more efficiently.

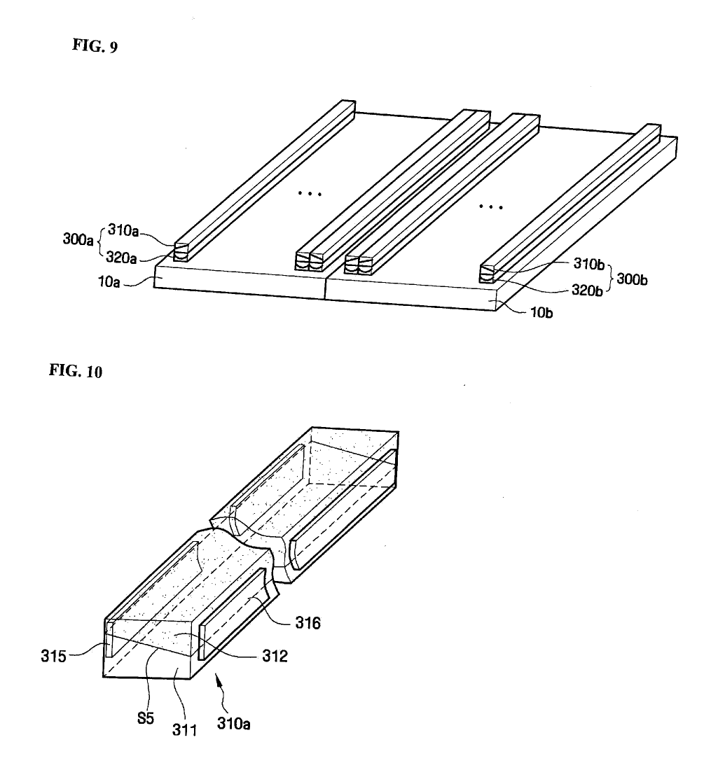

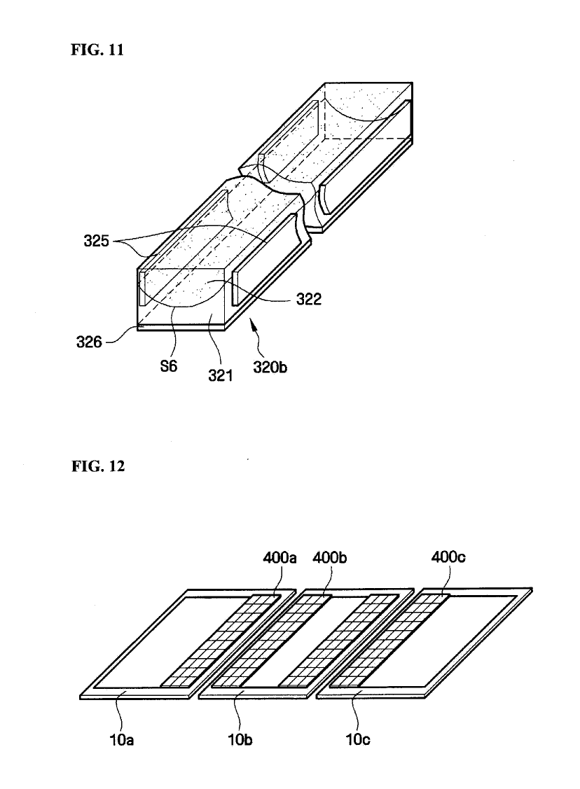

Hereinafter, a display device 1 according to a third exemplary embodiment of the present invention will be described in detail with reference to FIGS. 9 and 11. FIG. 9 is a perspective view of lens panels 300a and 300b and display panels 10a and 10b included in the display device 1 according to the third exemplary embodiment of the present invention. FIG. 10 is a perspective view of a first lens unit 310a included in the display device 1 of FIG. 9. FIG. 11 is a perspective view of a second lens unit 320b included in the display device 1 of FIG. 9. Elements having the same functions as those shown in the drawings for the first exemplary embodiment are indicated by like reference numerals, and thus their description will be omitted.

Referring to FIG. 9, the first lens unit 310a and a second lens unit 320a are repeatedly formed along a non-display region 12a (not shown) of the display panel 10a, and a first lens unit 310b and the second lens unit 320b are repeatedly formed along a non-display region 12b (not shown) of the display panel 10b. Thus, the first and second lens units 310a and 320a may overlap each row or column of pixels of the display panel 10a, and the first and second lens units 310b and 320b may overlap each row or column of pixels of the display panel 10b. That is, when each of the first and second lens units 310a and 320a or 310b and 320b, which are repeatedly formed along the non-display region 12a or 12b, is divided into a plurality of sections, each section of each of the first and second lens units 310a and 320a or 310b and 320b may be allocated to a pixel or a plurality of pixels. When each of the first and second lens units 310a and 320a or 310b and 320b, which are repeatedly formed along the non-display region 12a or 12b, is not divided into a plurality of sections, it may be allocated to each row or column of pixels of the display panel 10a or 10b.

Referring to FIG. 10, the first lens unit 310a of the lens panel 300a may be shaped like a long rectangle. First and second electrodes 315 and 316 are respectively disposed on both sides of a first liquid 311 and a second liquid 312 to face each other. The first and second electrodes 315 and 316 may extend parallel to the non-display region 12a.

When voltages are applied to the first and second electrodes 315 and 316, an interface S5 between the first liquid 311 and the second liquid 312 tilts to a side to be parallel to the non-display region 12a.

Referring to FIG. 11, the second lens unit 320b of the lens panel 300b may be shaped like a long rectangle. Two first electrodes 325 are respectively disposed on both sides of a first liquid 321 and a second liquid 322 to face each other, and a second electrode 326 is disposed under the first liquid 321. The same voltage is applied to the first electrodes 325 which are respectively disposed on both sides of the first liquid 321 and the second liquid 322 to face each other, and a voltage different from the voltage applied to the first electrodes 326 is applied to the second electrode 325.

When voltages are applied to the first and second electrodes 325 and 326, an interface S6 between the first liquid 321 and the second liquid 322 curves like a furrow to be parallel to the non-display region 12b. The interface S6 may function as a concave lens or a convex lens.

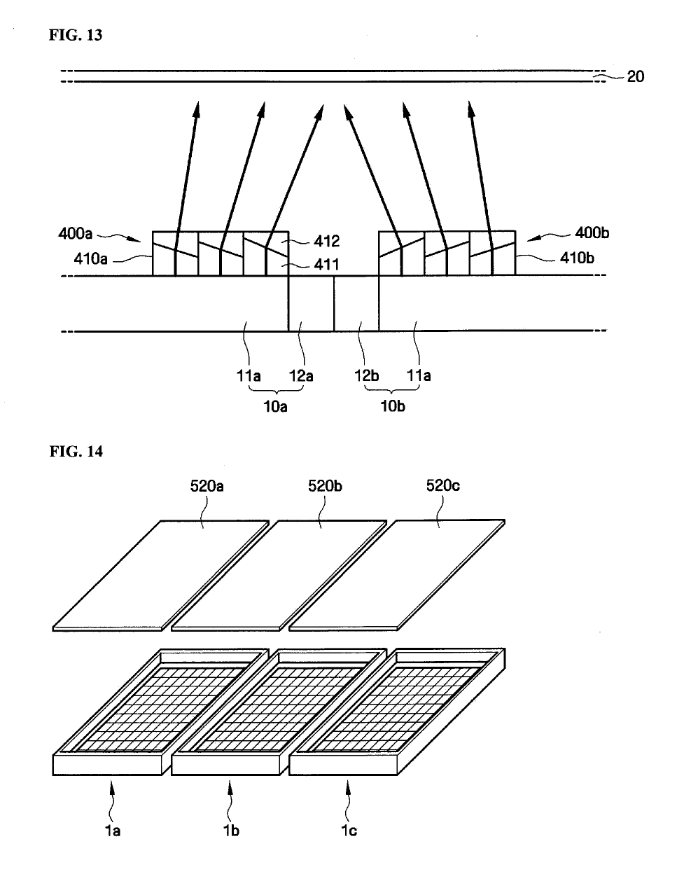

Hereinafter, a display device 1 according to a fourth exemplary embodiment of the present invention will be described in detail with reference to FIGS. 12 and 13. FIG. 12 is a perspective view of display panels 10a through 10c and lens panels 400a through 400c included in the display device 1 according to the fourth exemplary embodiment of the present invention. FIG. 13 is a schematic cross-sectional view of the display device 1 shown in FIG. 12. Elements having the same functions as those shown in the drawings for the first exemplary embodiment are indicated by like reference numerals, and thus their description will be omitted.

Referring to FIGS. 12 and 13, each of the lens panels 400a through 400c is formed in a region of the display panel 10a, 10b, or 10c. That is, since the lens panels 400a through 400c are designed to prevent non-display regions 12a and 12b of the display panels 10a and 10b and a non-display region (not shown) of the display panel 10c from being seen through the projection film 20, each of the lens panels 400a through 400c may be formed only in a region of the display panel 10a, 10b, or 10c which is adjacent to the non-display region 12a, 12b, or the non-display region (not shown) of the display panel 10c.

Each of the lens panels 400a through 400c may be formed to a predetermined width along a corresponding one of the non-display regions 12a and 12b of the display panels 10a and 10b and the non-display region (not shown) of the display panel 10c. Each of the lens panels 400a and 400b may include only a first lens unit 410a or 410b which can control the path of light. Likewise, the lens panel 400c may include only a first lens unit (not shown) which can control the path of light.

Regions of a projection film 20, which respectively overlap display regions 11a and 11b of the display panels 10a and 10b and a display region (not shown) of the display panel 10c, may receive images directly from the display panels 10a through 10c, respectively. On the other hand, regions of the projection film 20, which respectively overlap the non-display regions 12a and 12b of the display panels 10a and 10b and the non-display region (not shown) of the display panel 10c, may receive images from the display panels 10a through 10c through the first lens units 410a and 410b of the lens panels 400a and 400b and the first lens unit (not shown) of the lens panel 400c, respectively.

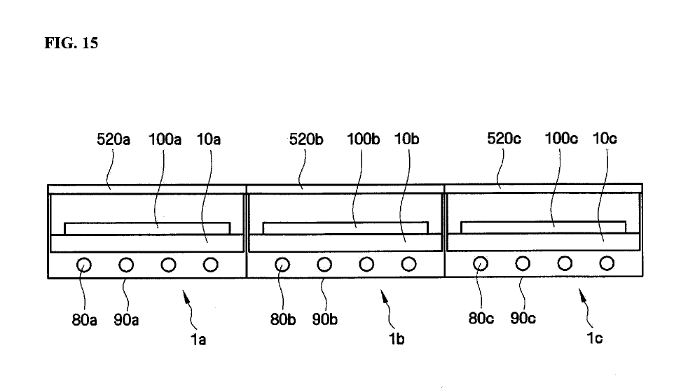

Hereinafter, a method of forming a multi-display apparatus by arranging a plurality of display devices according to an exemplary embodiment of the present invention will be described in detail with reference to FIGS. 14 and 15. FIG. 14 is a perspective view of a multi-display apparatus having a plurality of display devices 1a through 1c arranged adjacent to each other according to an exemplary embodiment of the present invention. FIG. 15 is a schematic cross-sectional view of the multi-display apparatus shown in FIG. 14. Elements having the same functions as those shown in the drawings for the first exemplary embodiment are indicated by like reference numerals, and thus their description will be omitted.

The display devices 1a through 1c may be connected to each other to form the multi-display apparatus. The display devices 1a through 1c may include lens panels 100a to 100c and projection films 520a through 520c, respectively. The projection films 520a through 520c may be as wide as the display panels 10a through 10c included in the display devices 1a through 1c, respectively.

Each of the display devices 1a through 1c includes the projection film 520a, 520b or 520c on a top surface thereof. When the display devices 1a through 1c are arranged adjacent to each other, the projection films 520a through 520c are also arranged adjacent to each other. Therefore, the projection films 520a through 520c of the display devices 1a through 1c function as unit screens, and the unit screens are arranged adjacent to each other to form a large screen.

When the display devices 1a through 1c are used separately, they function as separate devices. When the display devices 1a through 1c are arranged adjacent to each other, they form the multi-display apparatus and function as one large screen. The lens panels 100a through 100c magnify display regions of the display devices 1a through 1c, respectively, thereby minimizing the display of a non-display region of a large screen of the multi-display apparatus.

While the present invention has been particularly shown and described with reference to exemplary embodiments thereof, it will be understood by those of ordinary skill in the art that various changes in form and detail may be made therein without departing from the spirit and scope of the present invention as defined by the following claims. The exemplary embodiments should be considered in a descriptive sense only and not for purposes of limitation.

What is claimed is:

1. A display device comprising:
a display panel which displays an image;
a projection film which overlaps the display panel; and
a lens panel which comprises a first lens unit and is interposed between the display panel and the projection film,
wherein the first lens unit receives and refracts the image from the display panel and projects the image onto the projection film.

2. The display device of claim 1, wherein the display panel comprises:
a display region in which the image is displayed; and
a non-display region in which the image is not displayed and which surrounds the display region,
wherein the first lens unit outputs the image to a region of the projection film which overlaps the non-display region.

3. The display device of claim 2, wherein the first lens unit is formed in part of the display region which is adjacent to the non-display region.

4. The display device of claim 2, wherein a tilt angle of a refracting surface of the first lens unit, which refracts the image incident thereon, is gradually reduced as the distance from the non-display region increases.

5. The display device of claim 1, wherein the first lens unit comprises a liquid lens having a refracting surface which varies according to a voltage applied to the liquid lens.

6. The display device of claim 5, wherein the first lens unit comprises a first liquid and a second liquid having different refractive indices, and a tilt angle of an interface between the first liquid and the second liquid varies according to voltages applied to the first liquid and the second liquid.

7. The display device of claim 6, wherein the interface between the first liquid and the second liquid is a flat surface.

8. The display device of claim 6, wherein the first lens unit further comprises a first electrode and second electrode which are respectively disposed on opposing sidewalls of the first liquid and the second liquid.

9. The display device of claim 6, wherein the first lens unit comprises:
a first layer and a third layer which are made of the first liquid; and
a second layer which is interposed between the first layer and the third layer and made of the second liquid.

10. The display device of claim 9, wherein a tilt angle of an interface between the first layer and the second layer is different from a tilt angle of an interface between the second layer and the third layer.

11. The display device of claim 10, wherein the first lens unit further comprises:
first and second electrodes which are respectively disposed on opposing sidewalls of the first and second layers; and
third and fourth electrodes which are respectively disposed on opposing sidewalls of the second and third layers and are separated from the first and second electrodes.

12. The display device of claim 1, wherein the display panel comprises;
a display region in which the image is displayed; and
a non-display region where the image is not displayed and the non-display region surrounds the display region,
wherein the lens panel is formed along the non-display region and is divided into a plurality of sections or is disposed in sequence.

13. The display device of claim 1, wherein the lens panel further comprises a second lens unit which concentrates the image incident on the first lens unit.

14. The display device of claim 13, wherein the second lens unit comprises a liquid lens having a refracting surface which varies according to a voltage applied to the liquid lens.

15. The display device of claim 14, wherein the second lens unit comprises a first liquid and a second liquid having different refractive indices, and a voltage is applied between the first liquid and the second liquid such that a boundary surface between the first liquid and the second liquid is curved to form a convex or concave lens.

16. The display device of claim 15, wherein the first liquid and the second liquid are sequentially stacked, and the second lens unit further comprises a first electrode which is disposed on sides of the first liquid and the second liquid and a second electrode which is formed adjacent to one of the first liquid and the second liquid.

17. The display device of claim 1, wherein the projection film overlaps a plurality of display panels.

18. The display device of claim 1, wherein the projection film is a diffusion sheet or a diffusion plate.

19. A display device comprising:
a plurality of display panels which are arranged adjacent to each other and each of which comprises a display region where an image is displayed and a non-display region where the image is not displayed;
a projection film which overlaps the display panels; and
a lens panel which is interposed between the display panels and the projection film and comprises a first lens unit which adjusts an output direction of the image and projects the image onto the projection film,
wherein the display panels have a portion formed by the non-display regions which are disposed adjacent to each other, and the first lens unit projects the image onto a region of the projection film which overlaps the non-display regions.

20. The display device of claim 19, wherein the first lens unit further comprises a first liquid and a second liquid having refractive indices, and a voltage is applied between the first liquid and the second liquid to adjust an angle of an interface between the first liquid and the second liquid.

21. The display device of claim 19, wherein the lens panel further comprises a second lens unit which is interposed between the display panels and the projection film and concentrates the image.

22. The display device of claim 21, wherein the second lens unit comprises a first liquid and a second liquid having different refractive indices, and a voltage is applied to the first liquid and the second liquid such that an interface between the first liquid and the second liquid is curved to form a convex or concave lens.
